(19) United States
(12) Patent Application Publication
(10) Pub. No.: US 2015/0136931 A1
(43) Pub. Date: May 21, 2015

(54) Jack Stand Support

(71) Applicants: Andrew Fearon, Brooklyn, NY (US); Chantelle Fearon, Brooklyn, NY (US)

(72) Inventors: Andrew Fearon, Brooklyn, NY (US); Chantelle Fearon, Brooklyn, NY (US)

(21) Appl. No.: 14/335,204

(22) Filed: Jul. 18, 2014

Related U.S. Application Data
(60) Provisional application No. 61/847,886, filed on Jul. 18, 2013.

(51) Int. Cl. B66F 13/00

(52) U.S. Cl. CPC B66F 13/00
USPC 248/346.03

(57) ABSTRACT

Disclosed is a jack stand support that is adapted to be positioned under a standard jack stand. The present invention includes a base member having a defined outer and inner perimeter. In one embodiment, the base member is rectangular in shape and includes a rectangular central opening. The outer perimeter of the base member includes an upstanding wall that extends vertically therefrom. The upstanding wall is preferably welded to the base member so that the upstanding wall is perpendicular to the base member and the device is substantially unitary in structure. The upstanding wall is adapted to retain the jack stand on top of the base member so that the jack stand does not shift during use. The base member evenly distributes the weight of the jack stand so that it may be stabilized and prevented from sinking or slipping on the ground.

### CROSS REFERENCE TO RELATED APPLICATION

This application claims the benefit of U.S. Provisional Application No. 61/847,886 filed on Jul. 18, 2013. The above identified patent application is herein incorporated by reference in its entirety to provide continuity of disclosure.

### BACKGROUND OF THE INVENTION

1. Field of the Invention

The present invention relates to a jack stand support. More specifically, the present invention pertains to an improved jack stand support having a retaining means that is adapted to removably attach to the lower end of a standard jack stand.

Jack stands are used to lift and support a vehicle when working under a vehicle. To ensure safe and secure lift of vehicles, it is critical to place jack stands on a stable, level surface. However, jack stands tend to slide during use or sink into the ground even when they are placed on a level surface. Additionally, even quality jack stands can collapse if they are not positioned properly, and can fail suddenly without warning. It is therefore hazardous and dangerous to work under a vehicle as jack stands can fail unexpectedly, causing the vehicle to collapse on top of a user, resulting in a serious injury or even death.

To increase the stability of jack stands, traditional jack stands comprise a wide base or a plurality of legs that extend downward at an angle. When jack stands move or shift during use, however, the weight of the vehicle can be unevenly distributed on the base or the legs of the jack stands, causing the base or the legs to break or snap. Thus, there is a need for a device that evenly distributes the weight of the vehicle while providing increased support to the jack stand.

The present invention is a jack stand support having a base member that keeps the jack stand in a stable position. The device may be used indoors to prevent sliding and scratching, as well as outdoors to prevent a jack stand from sinking into the ground or shifting on an uneven surface. This is accomplished by providing a base member that can be positioned under a standard jack stand. The base member comprises an upstanding wall along the periphery thereof. The upstanding wall retains the jack stand on top of the base member, which functions to distribute the weight of the jack stand at each of the corners thereof. The device can be used with a wide variety of jack stands, so that it may be used with existing jack stands and retrofitted thereto. For many auto mechanics and service technicians, as well as consumers, the present invention can help prevent bodily injuries, as well as damage to vehicles.

2. Description of the Prior Art

Devices have been disclosed in the prior art that claim jack supports and jack stands. These include devices that have been patented and published in patent application publications, and generally include a foot plate or a wide base attached at each corner of the jack. The plates distribute the weight of the jack stand so that the device can be used on soft ground and prevent the corners from sinking into the ground. These devices, however, do not disclose an upstanding wall to retain the jack stand on top of the base member. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 6,644,615 to Liu discloses a stabilized jack stand comprising a square shaped foot element having a plurality of upstanding legs extending vertically upward therefrom. Each of the legs is attached to the foot element via an engagement element such as a bolt and a wing nut. Similarly, U.S. Pat. No. 3,599,923 to Hunnicutt discloses a load supporting stand comprising a plurality of legs that are affixed to a base having upstanding flanges, which restrain the ends of the legs from lateral movement. It is contemplated that the legs are permanently affixed to the base to increase the load-bearing capability of each leg.

The foregoing Liu and Hunnicutt devices are directed toward jack stands with a rectangular base affixed to each of the legs of the jack stand. While the rectangular base helps stabilize the jack stand on a ground surface, the devices of Liu and Hunnicutt are limited in the fact that they are adapted to be used with the jack stand on which it is mounted. In contrast, the present invention comprises a jack stand support that may be used with a wide variety of jack stands. Furthermore, the upstanding wall of the present invention eliminates the need for fasteners to secure the jack stand thereon. In this way, the present invention provides a versatile and convenient device for stabilizing a jack stand during use thereof.

U.S. Pat. No. 1,350,970 to Edwards discloses a base for jack stands. The base comprises a rigid, rectangular member having a planar upper and lower surface. The upper surface of the base is adapted to be removably secured to a jack stand via securing means such as nuts and bolts. While Edwards discloses a jack stand base that may be removably attached to a jack stand, Edwards does not disclose a base having an upstanding wall disposed around the periphery of the base. The present invention provides a jack stand support having an upstanding wall around the periphery of the base. The upstanding wall prevent the jack stand support from shifting within the support while in use. Additionally, the jack stand support of the present invention is dimensioned to snugly hold the jack stand therein, thereby eliminating the need for use of fasteners or securing means.

U.S. Pat. No. 7,490,808 to Lemirande discloses stackable jack stands having a base defining a central opening, a support bar centrally disposed above the base, and a plurality of legs connecting the open base to the support bar. The support bar has a length less than the length of the central opening of the base so that one jack stand may be placed over another. While Lemirande discloses jack stands having a base with a central opening, the disposition of the support bar and the legs prevent a user from placing a standard jack stand on the base. Thus, the device of Lemirande is inoperable for use with conventional jack stands. In contrast, the present invention comprises a jack stand support that is adapted to removably attach to a bottom portion of a jack stand. In this way, the present invention does not interfere with the structure and design of a standard jack stand during use.

Finally, U.S. Pat. No. 4,548,418 to Wendorff discloses a trailer support stand comprising a pyramidal frame having a triangular cross section. The stand comprises a triangular base and three legs that extend upwardly therefrom, forming a common point. The common point comprises a ball that is adapted to engage a socket coupling member on a trailer tongue. The purpose and intent of the Wendorff device, however, differ from the present invention. More specifically, the Wendorff device comprises a trailer support stand with upstanding legs that form a common point. In contrast, the present invention discloses a support for a jack stand with an upstanding wall that does not form a common point. The upstanding wall of the present invention is configured to slightly extend above only the lower end of a jack stand. In this way, the present invention does not interfere with the top portion of the jack stand.

The devices disclosed in the prior art have several known drawbacks. These devices are limited for use with certain types of jack stands and do not provide enough clearance for the top portion of the jack stand. The present invention overcomes these limitations by disclosing a support for a jack stand with an upstanding wall that slightly extends above the lower end of the jack stand to secure the same. It is therefore submitted that the present invention is substantially divergent in design elements from the prior art, and consequently it is clear that there is a need in the art for an improvement to jack stands. In this regard, the instant invention substantially fulfills these needs.

### SUMMARY OF THE INVENTION

In view of the foregoing disadvantages inherent in the known types of jack stands now present in the prior art, the present invention provides a new and improved jack stand support wherein the same can be utilized for evenly distributing the weight of a jack stand while increasing the amount of support to the jack stand.

It is therefore an object of the invention to provide a new and improved jack stand support that has all of the advantages of the prior art and none of the disadvantages.

Another object of the present invention is to provide a new and improved jack stand support that facilitates the even distribution of weight of a jack stand in order to enable the jack stand to remain in a stable position and to prevent sliding or shifting during use.

Yet another object of the present invention is to provide a new and improved jack stand support having an upstanding wall to securely hold the lower end of a jack stand without using fastening means.

Still yet another object of the present invention is to provide a new and improved jack stand support that protects ground surfaces from scratches and damage.

Still yet another object of the present invention is to provide a new and improved jack stand support that is suitable for indoor and outdoor use.

Still yet another object of the present invention is to provide a new and improved jack stand support that may be built onto new jack stands or retrofitted to existing jack stands.

Still yet another object of the present invention is to provide a new and improved jack stand support that may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a perspective view of the present invention.

FIG. 2 shows a view of the present invention in use.

FIG. 3 shows a close up view of the present invention as placed under a standard jack stand.

### DETAILED DESCRIPTION OF THE INVENTION

References are made herein to the attached drawings. Like reference numerals are used throughout the drawings to depict like or similar elements of the jack stand support. For the purposes of presenting a brief and clear description of the present invention, the preferred embodiment will be discussed as used evenly distribute the weight of a jack stand while increasing the amount of support to the jack stand. The figures are intended for representative purposes only and should not be considered to be limiting in any respect.

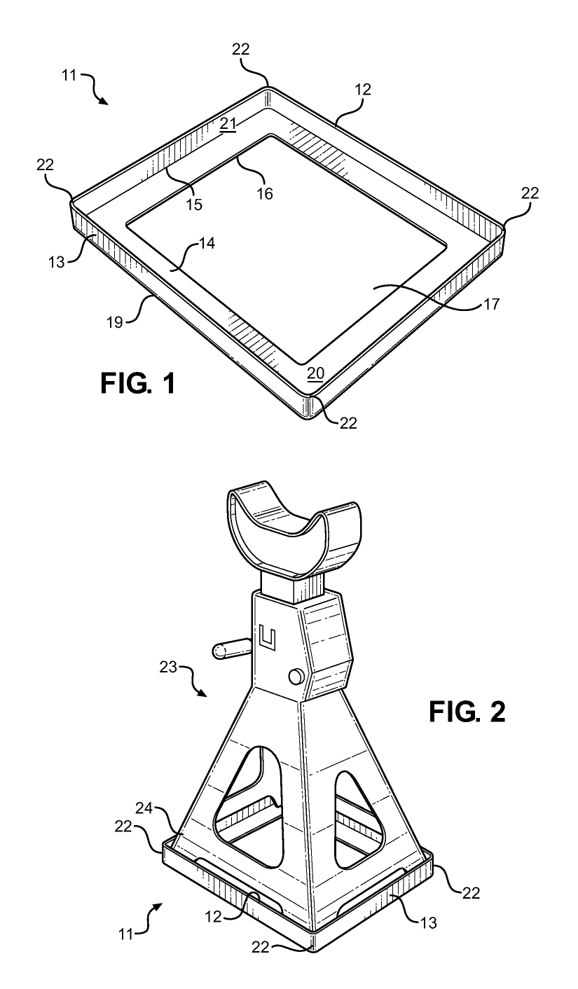

Referring now to FIG. 1, there is shown a perspective view of the jack stand support 11 of the present invention. The jack stand support 11 is composed of metal such as steel, or other suitable material that is resistant to corrosion. The jack stand support 11 comprises a rectangular base member 14 having an outer perimeter 15, an inner perimeter 16, forming a smooth, flat upper surface 20 therebetween, and a central opening 17. It is further completed that a bottom surface of the base member 14 is flat so as to be level when placed on the ground. In some embodiments, the bottom surface of the base member 14 may further comprise a high friction surface or a set of treading thereon to further prevent the jack stand support 11 from moving when placed on the ground.

In the illustrated embodiment, the inner perimeter 16 and the outer perimeter 15 of the base member 14 are shaped similarly. It is preferred that the inner perimeter 16 and the outer perimeter 15 of the base member are constructed so that the width of the upper surface 20 is constant at any point thereof. The inner perimeter 16 of the base member 14 defines the shape of the central opening 17, which substantially rectangular in shape. The central opening 17 aids in installing and removing the jack stand support 11 by providing a gripping portion to the user and eliminating air pressure when a jack stand is installed. In some embodiments, the inner perimeter 16 of the base member 14 may comprise a rounded rim to provide a smooth, reinforced edge.

The jack stand support 11 further comprises an upstanding wall 13 that extends vertically from the outer perimeter 15 of the base member 14 forming a plurality of corners 22 therebetween. The upstanding wall 13 comprises an upper perimeter 12, a lower perimeter 19, and an inner surface 21. In some embodiments, the upper perimeter 12 of the upstanding wall 13 may comprise a rim that to provide a smooth, reinforced edge, similar to that of the inner perimeter 16 of the base member 14.

The upper perimeter 12 and lower perimeter 19 of the upstanding wall 13 are substantially equal in dimension to the outer perimeter 15 of the base member 14. The rectangular base member 14 is preferably welded to the upstanding wall 13 so that the upstanding wall 13 is substantially perpendicular to the base member 14. Alternatively, the base member 14 and the upstanding wall 13 may be permanently affixed via strong adhesive or the like. In this way, the base member 14 and the upstanding wall 13 are unitary in structure so that the inner surface 21 of the upstanding wall 13 is contiguous to the upper surface 20 of the base member 14.

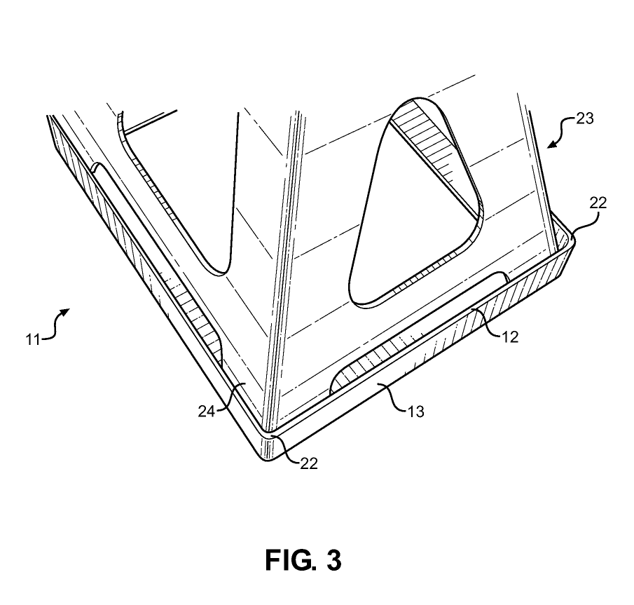

Referring now to FIGS. 2 and 3, there are shown views of the jack stand support 11 of the present invention in use with a conventional jack stand 23. The jack stand support 11 is dimensioned to snugly fit onto a lower end 24 of the jack stand 23. As such, the upper perimeter 12, lower perimeter 19, and the outer perimeter 15 are slightly larger in dimension relative to the periphery of the lower end 24 of the jack stand 23. It is preferred that the central opening of the jack stand support 11 is dimensioned to prevent the jack stand 23 from falling or slipping therethrough.

The jack stand 23 is positioned so that the lower end 24 of the jack stand 23 rests on top of the base member and laterally adjacent to the inner surface of the upstanding wall 13 so that the upstanding wall 13 surrounds the lower end 24 of the jack stand 23. In a preferred embodiment, the upper perimeter 12 of the upstanding wall 13 only slightly extends above the lower end 24 of the jack stand 23. Additionally, each of the corners 22 of the jack stand support 11 is configured to receive each of the corners of a jack stand 23 so as to evenly distribute the weight of the same. In this way, the present invention can be used with a variety of jack stands 23 as it lacks any structural component that would interfere with the top portion of a jack stand 23.

When the jack stand 23 is in use, the weight of a vehicle exerts force onto each of the legs on the lower end 24 of the jack stand 23. As force is applied, the legs on the lower end 24 are pressed against each of the corners 22 disposed between the base member and the upstanding wall 13 of the jack stand support 11. Each of the base member and the upstanding wall 13 is constructed to withstand the pressure from each of the legs on the lower end 24. Additionally, the upstanding wall 13 aids in retaining jack stands 23 snugly within the jack stand support 11. Because each of the legs press against each of the corners 22, the weight of the vehicle is evenly distributed throughout the jack stand support 11. In this way, the present invention prevents the jack stand 23 from tipping over or leaning to one side, which can lead to bending and breaking.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A jack stand support, comprising:
a rectangular base member having an outer perimeter, an inner perimeter defining a central opening, and an upper surface on which a jack stand can be positioned;
an upstanding wall having an upper perimeter, a lower perimeter, an inner surface;
said upstanding wall extending vertically from said outer perimeter of said base member and adapted to bound a jack stand placed on said base member.

2) The jack stand support of claim 1, wherein said rectangular base member and said upstanding wall are unitary in structure.

3) The jack stand support of claim 1, wherein said upper perimeter, said lower perimeter, and said outer perimeter are equal in dimension.

4) The jack stand support of claim 1, wherein said inner surface and said upper surface are contiguous.

5) The jack stand support of claim 1, wherein said base member is perpendicular to said upstanding wall.

6) The jack stand support of claim 1, wherein said central opening is rectangular.

7) The jack stand support of claim 1, wherein a lower surface of said base member comprises a high friction material thereon.
